(19) United States
(12) Patent Application Publication
(10) Pub. No.: US 2017/0334138 A1
(43) Pub. Date: Nov. 23, 2017

(54) DETERMINING HEATER MALFUNCTION

(71) Applicant: Hewlett-Packard Development Company, L.P., Houston, TX (US)

(72) Inventors: Xavier Vilajosana, Sant Cugat del Valles (ES); Sebastia Cortes, Barcelona (ES); Yngvar Rossow, Sant Cugat del Valles (ES)

(73) Assignee: Hewlett-Packard Development Company, L.P., Houston, TX (US)

(21) Appl. No.: 15/521,882

(22) PCT Filed: Jan. 28, 2015
(86) PCT No.: PCT/US2015/013223

§ 371 Date: Apr. 25, 2017

(51) Int. Cl. B29C 64/295; B33Y 30/00

(52) U.S. Cl. CPC B29C 64/295; B33Y 30/00

(57) ABSTRACT

A heater may be to heat build material during a three-dimensional print job. A sensor may be to measure a temperature distribution of the build material. A processor may be to obtain first temperature data representing a first temperature distribution of build material associated with normal functioning of the heater. The processor may be to obtain second temperature data representing a second temperature distribution of the build material to be measured by the temperature sensor during the three-dimensional print job. The processor may be to compare the first temperature distribution to the second temperature distribution. The processor may be to determine whether the heater is malfunctioning based on the comparison.

### BACKGROUND

Additive manufacturing systems that generate three-dimensional objects on a layer-by-layer basis have been proposed as a potentially convenient way to produce three-dimensional objects. The quality of objects produced by such systems may vary widely depending on the type of additive manufacturing technology used.

### BRIEF DESCRIPTION

Some examples are described with respect to the following figures:

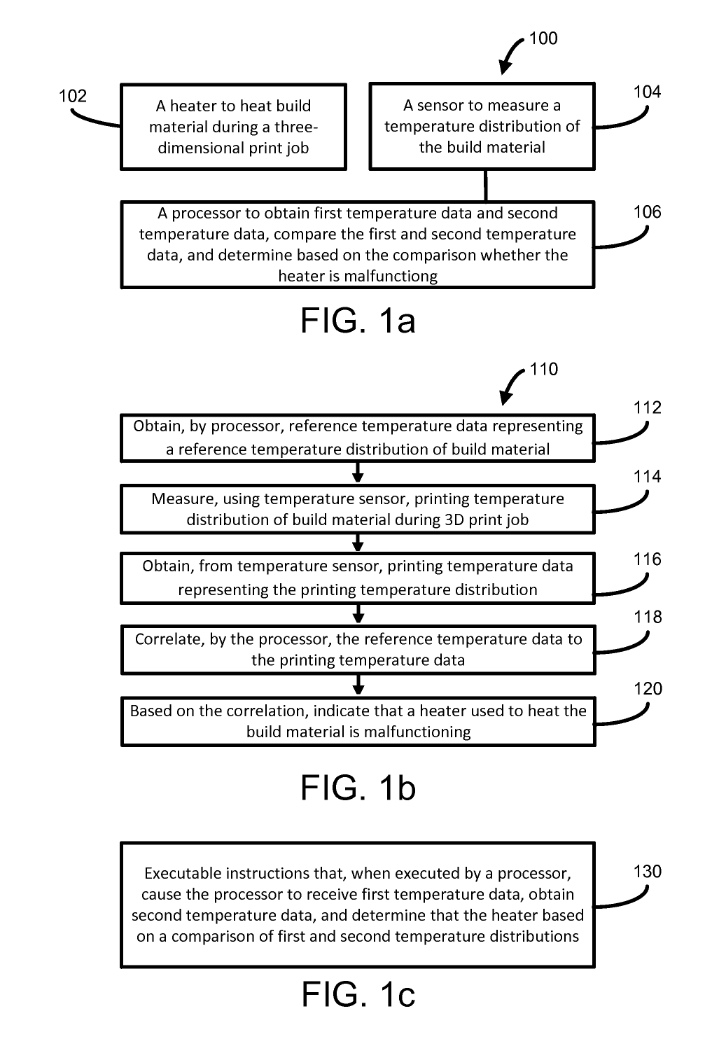

FIG. 1a illustrates a system for generating a three-dimensional object according to some examples;

FIG. 1b is a flow diagram illustrating a method according to some examples;

FIG. 1c is a block diagram illustrating a non-transitory computer readable storage medium according to some examples;

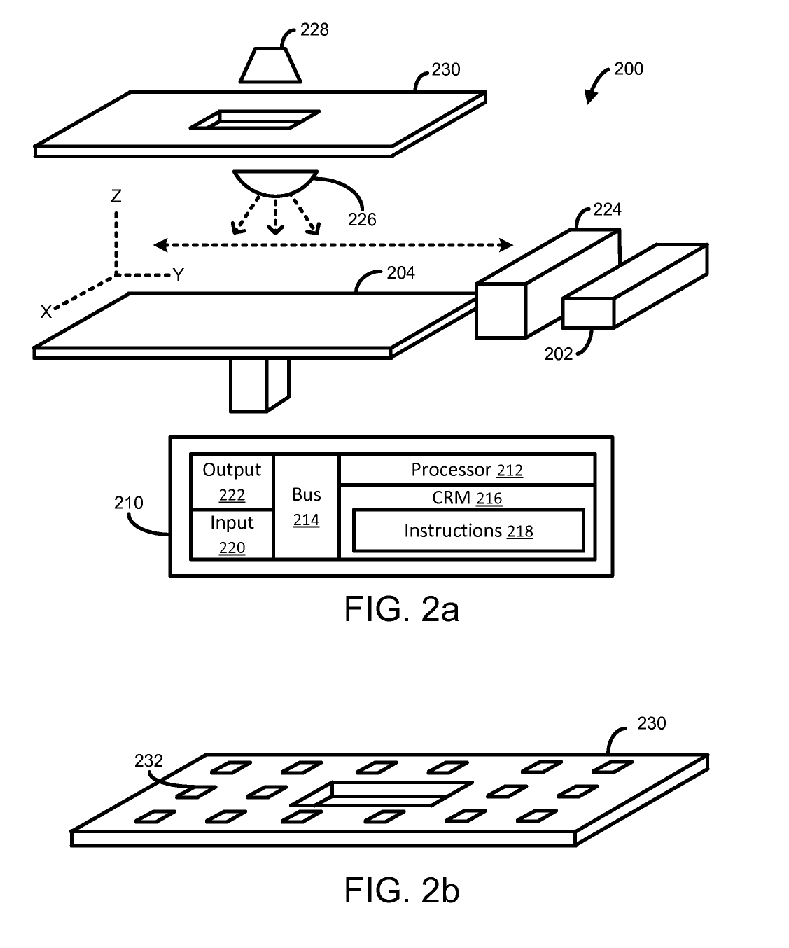

FIG. 2a is a simplified isometric illustration of an additive manufacturing system according to some examples;

FIG. 2b is a simplified isometric illustration of a heater for an additive manufacturing system according to some examples;

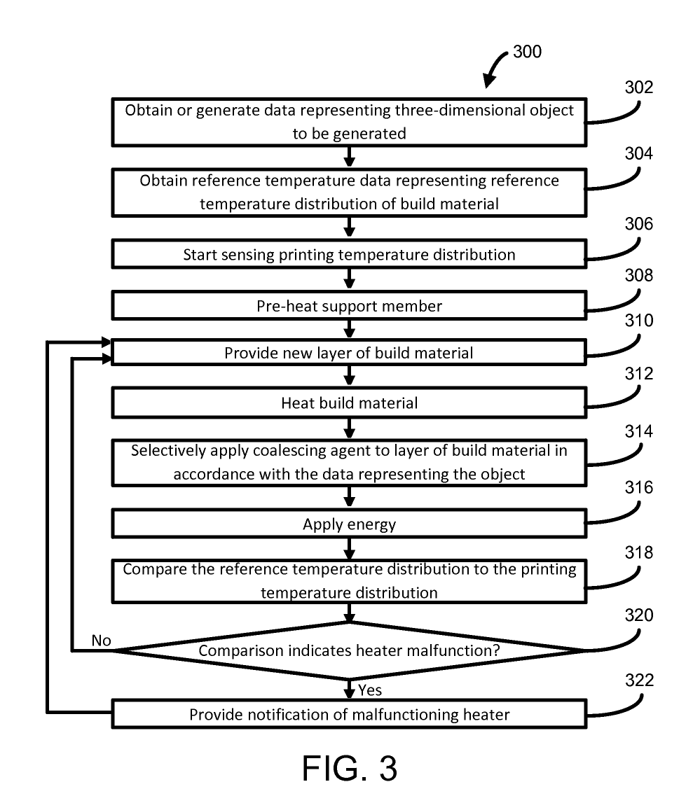

FIG. 3 is a flow diagram illustrating a method of generating a three-dimensional object according to some examples;

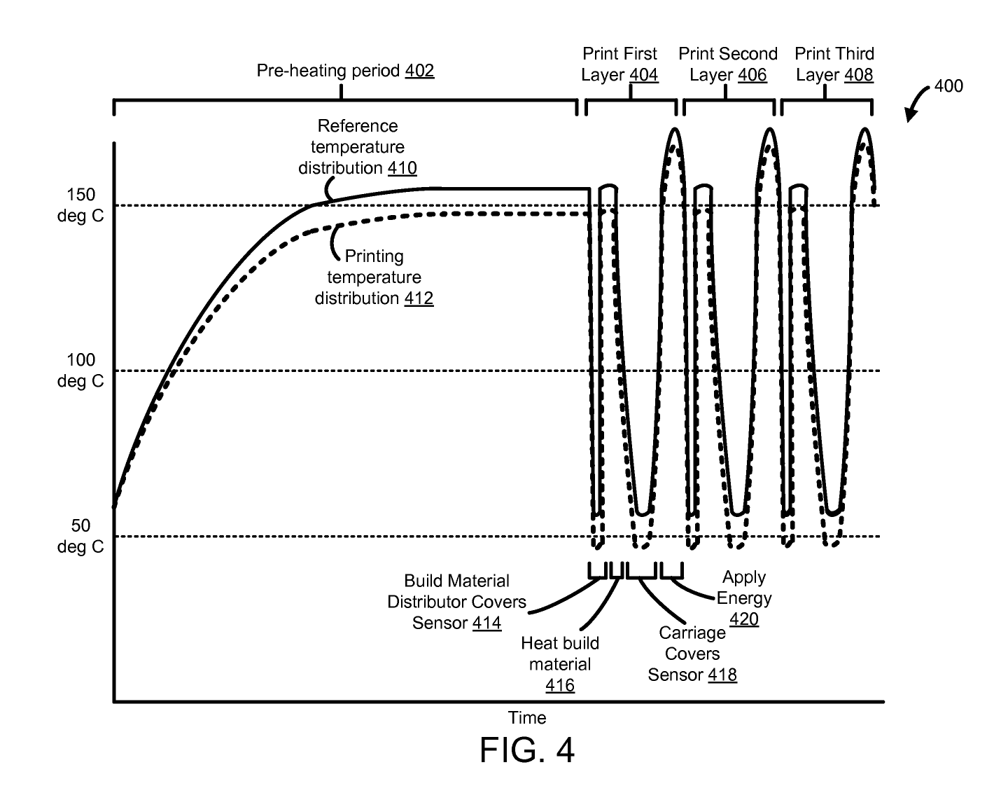

FIG. 4 illustrates a chart depicting temperature distributions according to some examples;

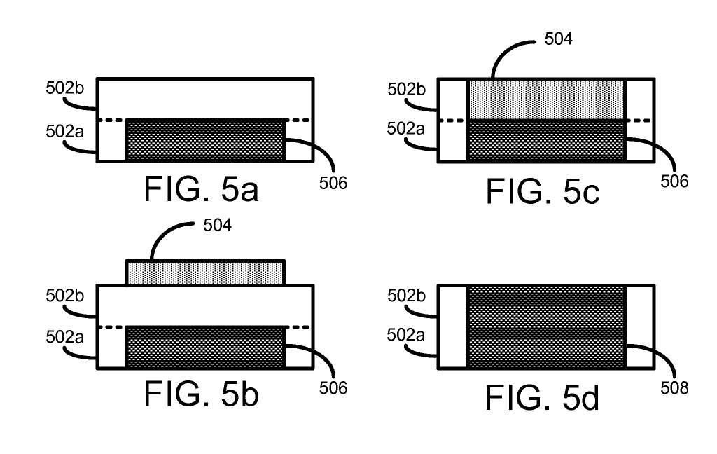

FIGS. 5a-d show a series of cross-sectional side views of layers of build material according to some examples; and

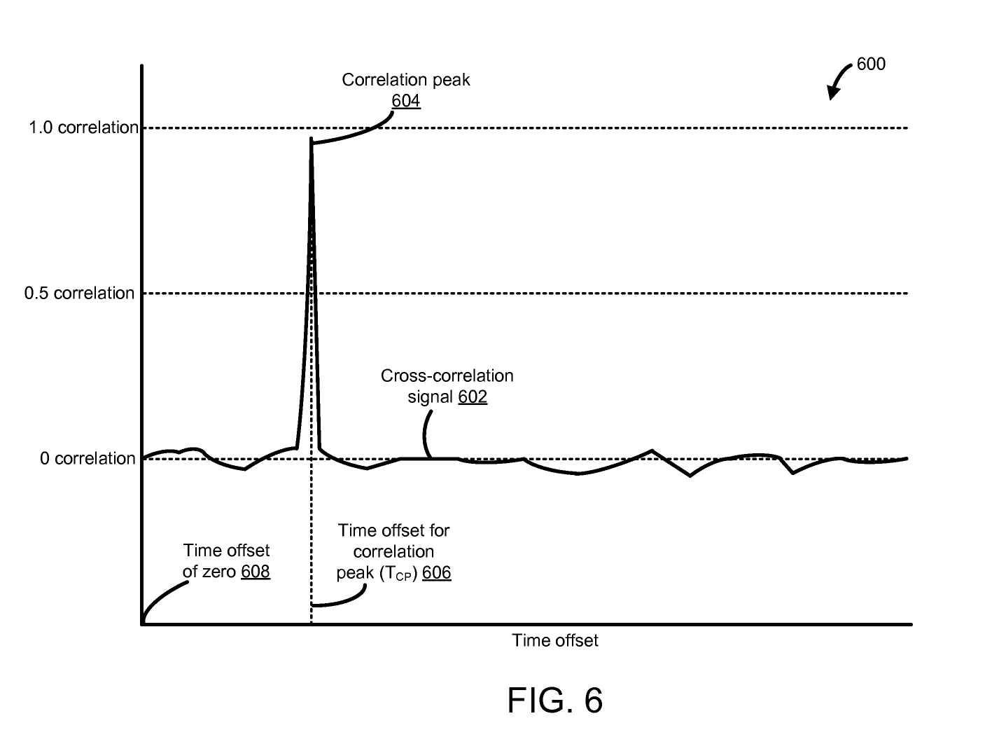

FIG. 6 illustrating a chart depicting a cross-correlation of temperature distributions according to some examples.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Some additive manufacturing systems generate three-dimensional objects through the solidification of portions of successive layers of build material, such as a powdered or liquid build material. The properties of generated objects may be dependent on the type of build material and the type of solidification mechanism used. In some examples, solidification may be achieved using a liquid binder agent to chemically solidify build material. In other examples, solidification may be achieved by temporary application of energy to the build material. This may, for example, involve use of a coalescing agent, which is a material that, when a suitable amount of energy is applied to a combination of build material and coalescing agent, may cause the build material to coalesce and solidify. In some examples, a multiple agent additive manufacturing system may be used such as that described in PCT Application No. PCT/EP2014/050841 filed on Jan. 16, 2014, entitled “GENERATING A THREE-DIMENSIONAL OBJECT”, the entire contents of which are hereby incorporated herein by reference. For example, in addition to selectively delivering coalescing agent to layers build material, coalescence modifier agent may also be selectively delivered to layers of build material. A coalescence modifier agent may serve to modify the degree of coalescence of a portion of build material on which the coalescence modifier agent has been delivered or has penetrated. In yet other examples, other methods of solidification may be used, for example selective laser sintering (SLS), light polymerization, among others. The examples described herein may be used with any of the above additive manufacturing systems and suitable adaptations thereof.

In some examples, an aspect of the additive manufacturing system such as a heater for heating build material may malfunction. This may result in temperature irregularities throughout the build material while generating the three-dimensional object. Since accurate object generation depends on maintaining build material temperatures within a narrow window, temperature irregularities may result in generated objects not being faithful reproductions of three-dimensional object models used to generate the objects. Accordingly, the present disclosure provides for determining whether the heater is malfunctioning.

FIG. 1a is a block diagram illustrating a system 100 according to some examples. A heater 102 may be to heat build material during a three-dimensional print job. A sensor 104 may be to measure a temperature distribution of the build material. A processor 106 may be to obtain first temperature data representing a first temperature distribution of build material associated with normal functioning of the heater. The processor 106 may be to obtain second temperature data representing a second temperature distribution of the build material to be measured by the sensor during the three-dimensional print job. The processor 106 may be to compare the first temperature distribution to the second temperature distribution. The processor 106 may be to determine whether the heater is malfunctioning based on the comparison. “Temperature data” are understood herein to refer to data that explicitly includes temperature values or indirectly includes temperature values, for example includes values of detected radiation received from an element being measured.

FIG. 1b is a flow diagram illustrating a method 110 according to some examples. At 112, reference temperature data representing a reference temperature distribution of build material may be obtained by a processor. At 114, a printing temperature distribution of the build material during a three-dimensional print job may be measured using a temperature sensor. At 116, printing temperature data representing the printing temperature distribution may be obtained from a temperature sensor. At 118, the reference temperature data to the printing temperature data may be correlated by the processor. At 120, based on the correlation, it may be indicated that a heater used to heat the build material is malfunctioning.

FIG. 1c is a block diagram illustrating a non-transitory computer readable storage medium 130 according to some examples. The non-transitory computer readable storage medium 130 may include executable instructions that, when executed by a processor, cause the processor to receive first temperature data representing a first temperature distribution of build material associated with normal functioning of a heating unit of a heater to heat build material during a three-dimensional print job. The non-transitory computer readable storage medium 130 may include executable instructions that, when executed by a processor, cause the processor to obtain second temperature data representing a second temperature distribution of the build material to be measured by the temperature sensor during the three-dimensional print job. The non-transitory computer readable storage medium 130 may include executable instructions that, when executed by a processor, cause the processor determine that the heater is malfunctioning based on a comparison of the first temperature distribution and the second temperature distribution.

FIG. 2a is a simplified isometric illustration of an additive manufacturing system 200 according to some examples. The system 200 may be operated, as described further below with reference to the flow diagram of FIG. 3 to generate a three-dimensional object.

In some examples the build material may be a powder-based build material. As used herein the term powder-based materials is intended to encompass both dry and wet powder-based materials, particulate materials, and granular materials. In some examples, the build material may include a mixture of air and solid polymer particles, for example at a ratio of about 40% air and about 60% solid polymer particles. One suitable material may be Nylon 12, which is available, for example, from Sigma-Aldrich Co. LLC. Another suitable Nylon 12 material may be PA 2200 which is available from Electro Optical Systems EOS GmbH. Other examples of suitable build materials may include, for example, powdered metal materials, powdered composite materials, powdered ceramic materials, powdered glass materials, powdered resin material, powdered polymer materials, and the like, and combinations thereof. It should be understood, however, that the examples described herein are not limited to powder-based materials or to any of the materials listed above. In other examples the build material may be in the form of a paste, liquid or a gel. According to one example a suitable build material may be a powdered semi-crystalline thermoplastic material.

The additive manufacturing system 200 may include a system controller 210. Any of the operations and methods disclosed herein may be implemented and controlled in the additive manufacturing system 200 and/or controller 210.

The controller 210 may include a processor 212 for executing instructions that may implement the methods described herein. The processor 212 may, for example, be a microprocessor, a microcontroller, a programmable gate array, an application specific integrated circuit (ASIC), a computer processor, or the like. The processor 212 may, for example, include multiple cores on a chip, multiple cores across multiple chips, multiple cores across multiple devices, or combinations thereof. In some examples, the processor 212 may include at least one integrated circuit (IC), other control logic, other electronic circuits, or combinations thereof.

The controller 210 may support direct user interaction. For example, the additive manufacturing system 200 may include user input devices 220 coupled to the processor 212, such as a keyboard, touchpad, buttons, keypad, dials, mouse, track-ball, card reader, or other input devices. Additionally, the additive manufacturing system 200 may include output devices 222 coupled to the processor 212, such as a liquid crystal display (LCD), video monitor, touch screen display, a light-emitting diode (LED), or other output devices. The output devices 222 may be responsive to instructions to display textual information or graphical data.

The processor 212 may be in communication with a computer-readable storage medium 216 via a communication bus 214. The computer-readable storage medium 216 may include a single medium or multiple media. For example, the computer readable storage medium 216 may include one or both of a memory of the ASIC, and a separate memory in the controller 210. The computer readable storage medium 216 may be any electronic, magnetic, optical, or other physical storage device. For example, the computer-readable storage medium 216 may be, for example, random access memory (RAM), static memory, read only memory, an electrically erasable programmable read-only memory (EEPROM), a hard drive, an optical drive, a storage drive, a CD, a DVD, and the like. The computer-readable storage medium 216 may be non-transitory. The computer-readable storage medium 216 may store, encode, or carry computer executable instructions 218 that, when executed by the processor 212, may cause the processor 212 to perform any of the methods or operations disclosed herein according to various examples.

The system 200 may include a coalescing agent distributor 202 to selectively deliver coalescing agent to successive layers of build material provided on a support member 204. According to one non-limiting example, a suitable coalescing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light enhancers are dye based colored ink and pigment based colored ink, such as inks commercially known as CM993A and CE042A available from Hewlett-Packard Company.

The controller 210 controls the selective delivery of coalescing agent to a layer of provided build material in accordance with agent delivery control data 208 of the instructions 218.

The agent distributor 202 may be a printhead, such as a thermal inkjet printhead or a piezo inkjet printhead. The printhead may have arrays of nozzles. In one example, printheads such as those commonly used in commercially available inkjet printers may be used. In other examples, the agents may be delivered through spray nozzles rather than through printheads. Other delivery mechanisms may be used as well. The agent distributor 202 may be used to selectively deliver, e.g. deposit, coalescing agent when in the form of suitable fluids such as a liquid.

The coalescing agent distributor 202 may include a supply of coalescing agent or may be connectable to a separate supply of coalescing agent.

The agent distributor 202 may be used to selectively deliver, e.g. deposit, coalescing agent when in the form of a suitable fluid such as liquid. In some examples, the agent distributor 202 may be selected to deliver drops of agent at a resolution of between 300 to 1200 dots per inch (DPI), for example 600 DPI. In other examples the agent distributor 202 may be selected to be able to deliver drops of agent at a higher or lower resolution. In some examples, the agent distributor 202 may have an array of nozzles through which the agent distributor 202 is able to selectively eject drops of fluid. In some examples, each drop may be in the order of about 10 pico liters (pl) per drop, although in other examples the agent distributor 202 is able to deliver a higher or lower drop size. In some examples the agent distributor 202 is able to deliver variable size drops.

In some examples the coalescing agent may comprise a liquid carrier, such as water or any other suitable solvent or dispersant, to enable it to be delivered via a printhead.

In some examples the printheads may be drop-on-demand printhead. In other examples the printhead may be continuous drop printhead.

In some examples, the agent distributor 202 may be an integral part of the system 200. In some examples, the agent distributor 202 may be user replaceable, in which case they may be removably insertable into a suitable agent distributor receiver or interface module of the system 200.

In the example illustrated in FIG. 2a, the agent distributor 202 may have a length that enables it to span the whole width of the support member 204 in a so-called page-wide array configuration. In one example this may be achieved through a suitable arrangement of multiple printheads. In other examples a single printhead having an array of nozzles having a length to enable them to span the width of the support member 204 may be used. In other examples, the agent distributor 202 may have a shorter length that does not enable it to span the whole width of the support member 204.

The agent distributor 202 may be mounted on a moveable carriage to enable it to move bi-directionally across the length of the support 204 along the illustrated y-axis. This enables selective delivery of coalescing agent across the whole width and length of the support 204 in a single pass. In other examples the agent distributor 202 may be fixed, and the support member 204 may move relative to the agent distributor 202.

In other examples the agent distributors may be fixed, and the support member 204 may move relative to the agent distributors.

It should be noted that the term ‘width’ used herein is used to generally denote the shortest dimension in the plane parallel to the x and y axes illustrated in FIG. 2a, whilst the term ‘length’ used herein is used to generally denote the longest dimension in this plane. However, it will be understood that in other examples the term ‘width’ may be interchangeable with the term ‘length’. For example, in other examples the agent distributor 202 may have a length that enables them to span the whole length of the support member 204 whilst the moveable carriage may move bi-directionally across the width of the support member 204.

In another example the agent distributor 202 does not have a length that enables it to span the whole width of the support member but are additionally movable bi-directionally across the width of the support member 204 in the illustrated x-axis. This configuration enables selective delivery of coalescing agent across the whole width and length of the support 204 using multiple passes. Other configurations, however, such as a page-wide array configuration, may enable three-dimensional objects to be created faster.

The system 200 may further comprise a build material distributor 224 to provide, e.g. deliver and/or deposit, successive layers of build material on the support member 204. Suitable build material distributors 224 may include, for example, a wiper blade and a roller. Build material may be supplied to the build material distributor 224 from a hopper or build material store. In the example shown the build material distributor 224 moves across the length (y-axis) of the support member 204 to deposit a layer of build material. As previously described, a layer of build material will be deposited on the support member 204, whereas subsequent layers of build material will be deposited on a previously deposited layer of build material. The build material distributor 224 may be a fixed part of the system 200, or may not be a fixed part of the system 200, instead being, for example, a part of a removable module. In some examples, the build material distributor 224 may be mounted on the carriage 203a or 203b.

In some examples, the thickness of each layer may have a value selected from the range of between about 50 to about 300 microns, or about 90 to about 110 microns, or about 250 microns, although in other examples thinner or thicker layers of build material may be provided. The thickness may be controlled by the controller 210, for example based on the instructions 218.

In some examples, there may be any number of additional agent distributors and build material distributors relative to the distributors shown in FIG. 2a. In some examples, the distributors of system 200 may be located on the same carriage, either adjacent to each other or separated by a short distance. In other examples, two or more carriages each may contain a distributor. For example, each distributor may be located in its own separate carriage. Any additional distributors may have similar features as those discussed earlier with reference to the coalescing agent distributor 202. However, in some examples, different agent distributors may deliver different coalescing agents and/or coalescence modifier agents, for example.

In the example shown the support 204 is moveable in the z-axis such that as new layers of build material are deposited a predetermined gap is maintained between the surface of the most recently deposited layer of build material and lower surface of the agent distributor 202. In other examples, however, the support 204 may not be movable in the z-axis and the agent distributor 202 may be movable in the z-axis.

The system 200 may additionally include an energy source 226 to apply energy to build material to cause the solidification of portions of the build material according to where coalescing agent has been delivered or has penetrated. In some examples, the energy source 226 is an infra-red (IR) radiation source, near infra-red radiation source, halogen radiation source, or a light emitting diode. In some examples, the energy source 226 may be a single energy source that is able to uniformly apply energy to build material deposited on the support 204. In some examples, the energy source 226 may comprise an array of energy sources.

In some examples, the energy source 226 is configured to apply energy in a substantially uniform manner to the whole surface of a layer of build material. In these examples the energy source 226 may be said to be an unfocused energy source. In these examples, a whole layer may have energy applied thereto simultaneously, which may help increase the speed at which a three-dimensional object may be generated.

In other examples, the energy source 226 is configured to apply energy in a substantially uniform manner to a portion of the whole surface of a layer of build material. For example, the energy source 226 may be configured to apply energy to a strip of the whole surface of a layer of build material. In these examples the energy source may be moved or scanned across the layer of build material such that a substantially equal amount of energy is ultimately applied across the whole surface of a layer of build material.

In some examples, the energy source 226 may be mounted on the moveable carriage 203a or 203b.

In other examples, the energy source 226 may apply a variable amount of energy as it is moved across the layer of build material, for example in accordance with agent delivery control data 208 of instructions 218. For example, the controller 210 may control the energy source only to apply energy to portions of build material on which coalescing agent has been applied.

In further examples, the energy source 226 may be a focused energy source, such as a laser beam. In this example the laser beam may be controlled to scan across the whole or a portion of a layer of build material. In these examples the laser beam may be controlled to scan across a layer of build material in accordance with agent delivery control data. For example, the laser beam may be controlled to apply energy to those portions of a layer of on which coalescing agent is delivered.

The combination of the energy supplied, the build material, and the coalescing agent may be selected such that, excluding the effects of any coalescence bleed: i) portions of the build material on which no coalescing agent have been delivered do not coalesce when energy is temporarily applied thereto; ii) portions of the build material on which only coalescing agent has been delivered or has penetrated coalesce when energy is temporarily applied thereto do coalesce.

The system 200 may additionally include a heater 230 to emit heat to maintain build material deposited on the support 204 within a predetermined temperature range. The heater 230 may have any suitable configuration. One example is shown in FIG. 2b, which is a simplified isometric illustration of a heater 230 for an additive manufacturing system according to some examples. The heater 230 may have an array of heating units 232, as shown in FIG. 2b. The heating units 232 may be each be any suitable heating unit, for example a heat lamp such as an infra-red lamp. The heating units 232 may have any suitable shapes or configurations such as rectangular as shown in FIG. 2b. In other examples they may be circular, rod shaped, or bulb shaped, for example. The configuration may be optimized to provide a homogeneous heat distribution toward the area spanned by the build material. Each heating unit 232, or groups of heating units 232, may have an adjustable current or voltage supply to variably control the local energy density applied to the build material surface.

Each heating unit 232 may correspond to its own respective area of the build material, such that each heating unit 232 may emit heat substantially toward its own area rather than areas covered by other heating units 232. For example, each of the sixteen heating units 232 in FIG. 2b may heat one of sixteen different areas of the build material, where the sixteen areas collectively cover the entire area of the build material. However, in some examples, each heating unit 232 may also emit, to a lesser extent, some heat which influences an adjacent area.

In some examples, additionally or alternatively to the heater 230, a heater may be provided below the platen of the support member 204 to conductively heat the support member 204 and thereby the build material. The conductive heater may be to uniformly heat the build material across its area on the support member 204.

The system 200 may additionally include a sensor 228 for detecting temperature, for example a point contactless temperature sensor such as one or more thermopiles, or such as a thermographic camera. In other examples, the sensor 229 may include an array of fixed-location pyrometers which each capture radiation from a single area of the build material. In other examples, the sensor 229 may be a single pyrometer which may be operable to sweep or scan over the entire area of the build material. Other types of sensors may also be used.

The sensor 228 may be to capture a radiation distribution, for example in the IR range, emitted by each point of the build material across the area spanned by the build material on the support member 204. The sensor 228 may output the radiation distribution to the controller 210, which may determine a temperature distribution over time for each area across the build material based on known relationships, such as a black body distribution, between temperature and radiation intensity for the material used as the build material. For example, the radiation frequencies of the radiation distribution may have their highest intensities at particular values in the infra-red (IR) range. Each temperature distribution over time may correspond to a particular area of the build material, wherein each of the areas collectively define an entire area of the build material print bed. Additionally, each area for each temperature distribution may correspond to an area heated by a particular heating unit 232. Thus, if there are sixteen heating units 234 cover sixteen corresponding areas of build material, then there may be sixteen different measured temperature distributions each corresponding to one of the sixteen areas.

The sensor 228 may be oriented generally centrally and facing generally directly toward the build material, such that the optical axis of the camera targets the center line of the support member 204, to allow a generally symmetric capture of radiation from the build material. This may minimize perspective distortions of the build material surface, thus minimizing the need for corrections, and reducing errors in measured temperature values versus real temperature values. Additionally, the sensor 228 may be able to (1) capture the image over a wide region covering an entire layer of build material, for example by using suitable magnification, (2) capture a series of images of the entire layer which are later averaged, or (3) capture a series of images each covering a portion of the layer that together cover the entire layer. In some examples, the sensor 228 may be in a fixed location relative to the support member 204, but in other examples may be moveable if other components, when moving, disrupt the line of sight between the camera 228 and the support member 204.

In some examples, an array of sensors 228 may be used. Each sensor 228 may correspond to its own respective area of the build material, such that each sensor 228 may perform measurements on its own area rather than areas corresponding to other sensors 228.

The controller 210 may obtain or generate agent delivery control data 208 which may define for each slice of the three-dimensional object to be generated the portions or the locations on the build material, if any, at which agent is to be delivered.

In some examples, the agent delivery control data 208 may be generated based on object design data representing a three-dimensional model of an object to be generated, and/or from object design data representing properties of the object. The model may define the solid portions of the object, and may be processed by the three-dimensional object processing system to generate slices of parallel planes of the model. Each slice may define a portion of a respective layer of build material that is to be solidified by the additive manufacturing system. The object property data may define properties of the object such as density, surface roughness, strength, and the like.

The object design data and object property data may be received, for example, from a user via an input device 220, as input from a user, from a software driver, from a software application such as a computer aided design (CAD) application, or may be obtained from a memory storing default or user-defined object design data and object property data.

In some examples the object processing system may obtain data relating to characteristics of the additive manufacturing system 200. Such characteristics may include, for example, build material layer thickness, properties of the coalescing agent, properties of the build material, and properties of the energy source 226, properties of the heater 230, and properties of the sensor 228.

The agent delivery control data 208 may describe, for each layer of build material to be processed, locations or portions on the build material at which coalescing agent is to be delivered. In one example the locations or portions of the build material at which coalescing agent is to be delivered are defined by way of respective patterns.

FIG. 3 is a flow diagram illustrating a method 300 of generating a three-dimensional object according to some examples. In some examples, the orderings shown may be varied, some elements may occur simultaneously, some elements may be added, and some elements may be omitted.

In describing FIG. 3, reference will be made to FIGS. 2, 4, and 5a-d. FIG. 4 illustrates a chart 400 depicting temperature distributions 410 and 412 according to some examples. FIGS. 5a-d show a series of cross-sectional side views of layers of build material according to some examples. FIG. 6 illustrating a chart depicting a cross-correlation of temperature distributions 410 and 412 according to some examples.

At 302, the agent delivery control data 208 may be obtained, e.g. may be retrieved from the computer-readable medium 216 or generated.

At 304, data representing a reference temperature distribution over time of build material may be obtained, e.g. retrieved from the computer-readable medium 216 or measured. The reference temperature distribution over time may be measured during normal functioning of the heater 230 and therefore may represent optimal or intended temperature distributions to be achieved during print jobs. In some examples, the reference measurements may be made during previous print jobs. In some examples, the reference measurements may be made during initial stages of the current print job. In some examples, the reference measurements may be made during a calibration phase prior to the current print job.

The reference temperature distribution over time may be based on feedback obtained by the sensor 228, for example by capturing an image representing a radiation distribution of the build material as discussed earlier. The measured radiation distribution may be used by the controller 210 or by a processor in the sensor 228 to determine the reference temperature distribution over time for each area across the build material based on known relationships, such as a black body distribution, between temperature and radiation intensity for the material used as the build material, as discussed earlier. For each area, this may be used to determine a reference temperature distribution over time comprising a plurality of time-stamped temperatures across the build material. Each reference temperature distribution over time may correspond to a particular area of the build material, wherein each of the areas collectively define an entire area of the build material print bed. Additionally, each area for each reference temperature distribution may correspond to an area to be heated by a particular heating unit 232. Thus, if there are sixteen heating units 234 cover sixteen corresponding areas of build material, then there may be sixteen different measured temperature distributions each corresponding to one of the sixteen areas.

One such reference temperature distribution over time 410 is shown in FIG. 4, corresponding to one area of the build material and corresponding to one heating unit 232. However, multiple reference temperature distributions of over time may be obtained corresponding to multiple areas and heating units 234. As shown, the reference temperature distribution 410 includes a pre-heating period 402 corresponding to heating by the heater 232 to a predetermined temperature range (as in 308), then multiple layer printing periods 404, 406, and 408, although additional layer printing periods may be included. Each layer printing period may include a period 414 in which the detected temperature is lower because the build material distributor 224 covers the sensor 228 while providing a layer of build material (as in 310), a period 416 in which the layer of build material is heated to maintain the predetermined temperature range (as in 312), a period 418 in which the detected temperature is lower because the carriage having an agent distributor 202 covers the sensor 228 while the agent distributor 202 delivers coalescing agent (as in 314), and a period 420 in which the temperature spikes due to energy applied by the energy source 226 to cause the portions of build material having coalescing agent to coalesce and subsequently solidify (as in 316).

At 306, a printing temperature distribution over time of the layer 502b of build material may start to be obtained. For example, the sensor 228 may obtain feedback, for example by capturing an image representing a radiation distribution of the build material as discussed earlier. The sensor 228 may continually obtain feedback throughout the method 300.

The measured radiation distribution may be used by the controller 210 or by a processor in the sensor 228 to determine a printing temperature distribution over time for each area across the build material based on known relationships, such as a black body distribution, between temperature and radiation intensity for the material used as the build material, as discussed earlier. For each area, this may be used to determine a printing temperature distribution over time comprising a plurality of time-stamped temperatures across the build material. Each temperature distribution over time may correspond to a particular area of the build material, wherein each of the areas collectively define an entire area of the build material print bed. Additionally, each area for each temperature distribution may correspond to an area heated by a particular heating unit 232. Thus, if there are sixteen heating units 234 cover sixteen corresponding areas of build material, then there may be sixteen different measured temperature distributions each corresponding to one of the sixteen areas.

One such printing temperature distribution over time 412 is shown in FIG. 4, corresponding to one area of the build material and corresponding to one heating unit 232. However, multiple printing temperature distributions of over time may be obtained corresponding to multiple areas and heating units 234. The printing temperature distribution 412 includes similar periods 402, 404, 406, 408, 414, 416, 418, and 420 described earlier relative to the reference temperature distribution 410. The printing temperature distribution over time 412 is shown having completed three layers and therefore three iterations of 310 to 322 (or 310 to 324).

At 308, the support member 204 may be pre-heated by the heater 230 to maintain the build material to be delivered within a predetermined temperature range. The predetermined temperature range may, for example, be below the temperature at which the build material would experience bonding in the presence of coalescing agent 504. For example, the predetermined temperature range may be between about 155 and about 160 degrees Celsius, or the range may be centered at about 160 degrees Celsius. Pre-heating may help reduce the amount of energy that has to be applied by the energy source 226 to cause coalescence and subsequent solidification of build material on which coalescing agent has been delivered or has penetrated.

At 310, a layer 502b of build material may be provided, as shown in FIG. 5a. For example, the controller 210 may control the build material distributor 224 to provide the layer 502b on a previously completed layer 502a on the support member 204 by causing the build material distributor 224 to move along the y-axis as discussed earlier. The completed layer 502a may include a solidified portion 506. Although a completed layer 502a is shown in FIGS. 5a-d for illustrative purposes, it is understood that 310 to 322 (or 310 to 324) may initially be applied to generate the first layer 502a.

At 312, the layer 502b of build material may be heated by the heater 230 to heat and/or maintain the build material within the predetermined temperature range discussed earlier. The degree of heating needed to maintain the temperatures in the predetermined temperature range may be determined based on the printing temperature distributions over time

At 314, as shown in FIG. 5b, coalescing agent 504 may be selectively delivered to the surface of portions of the layer 502b. As discussed earlier, the agent 504 may be delivered by agent distributor 502, for example in the form of fluids such as liquid droplets.

The selective delivery of the agent 504 may be performed in patterns on the portions of the layer 502b that the data representing the three-dimensional object may define to become solid to form part of the three-dimensional object being generated. The data representing the three-dimensional object may be unmodified data if a dead zone was not identified and modified data if a dead zone was identified. “Selective delivery” means that agent may be delivered to selected portions of the surface layer of the build material in various patterns.

In some examples, coalescence modifier agent may similarly be selectively delivered to portions of the layer 602b.

FIG. 5c shows coalescing agent 504 having penetrated substantially completely into the portions of the layer 502b of build material, but in other examples, the degree of penetration may be less than 100%. The degree of penetration may depend, for example, on the quantity of agent delivered, on the nature of the build material, on the nature of the agent, etc.

At 316, a predetermined level of energy may be temporarily applied to the layer 502b of build material. In various examples, the energy applied may be infra-red or near infra-red energy, microwave energy, ultra-violet (UV) light, halogen light, ultra-sonic energy, or the like. The temporary application of energy may cause the portions of the build material on which coalescing agent 504 was delivered to heat up above the melting point of the build material and to coalesce. In some examples, the energy source may be focused. In other examples, the energy source may be unfocused, and the temporary application of energy may cause the portions of the build material on which coalescing agent 504 has been delivered or has penetrated to heat up above the melting point of the build material and to coalesce. For example, the temperature of some or all of the layer 502b may achieve about 220 degrees Celsius. Upon cooling, the portions having coalescing agent 504 may coalesce may become solid and form part of the three-dimensional object being generated, as shown in FIG. 5d.

As discussed earlier, one such solidified portion 506 may have been generated in a previous iteration. The heat absorbed during the application of energy may propagate to the previously solidified portion 506 to cause part of portion 506 to heat up above its melting point. This effect helps creates a portion 508 that has strong interlayer bonding between adjacent layers of solidified build material, as shown in FIG. 5d.

At 318, each printing temperature distribution over time 412 may be compared, by the controller 210, to its corresponding reference temperature distribution over time 410. For example, the printing temperature distribution over time 412 for a given print bed area may be cross-correlated by temporally matching it to its correspond reference temperature distribution over time 410, such that for comparison at 320, the same periods in the printing cycle may be compared. For example, the cross-correlation may ensure that the corresponding heating periods 402 of distributions 410 and 412 are compared, that the corresponding layer printing periods 404 of 410 and 412 are compared, etc., rather than, for example, a heating period 402 being inadvertently compared to a printing period 404.

The cross-correlation may be performed according to any suitable technique. The distributions 410 and 412 may be cross-correlated by selecting different time offsets. FIG. 6 shows a cross-correlation signal 602 showing correlations between the distributions 410 and 412 depending on the selected time offset. For example, in FIG. 6, the correlation at the time offset of zero 608 represents the correlation between the distributions 410 and 412 if the two distributions 410 and 412 are aligned at time zero of the data of each distribution. Since the correlation is zero, this means that, for example, the beginning of the pre-heating period does not begin at time zero of one or both of the data representing the distributions 410 and 412. However, the correlation at the time offset of the correlation peak (T_{CP}) 606 represents the correlation between the distributions 410 and 412 if time zero of the data representing distribution 410 is aligned to time T_{CP} of the data representing distribution 412 Since the correlation is close to 1, this means that, for example, the beginning of the pre-heating period begins at time zero of the data representing distribution 410 and time T_{CP} of the data representing distribution 412. Calculation of the correlation between two temperatures may be done, for example, by calculating (T_{Print Distribution 412}×T_{Ref Distribution 410})/(T_{Ref Distribution 410})̂2, where T_{Print Distribution 412} for each temperature correlation for each calculated time offset. If, for example, T_{Print Distribution 412}=T_{Ref Distribution 410}, then this calculation yields 1.

In some examples, the cross-correlation may be performed on the entire data sets of the distributions 410 and 412, or in other examples, each of the data sets may be separated into parts, and the parts of the data sets may be compared. In some examples, rather than the method described above, other statistical techniques may be used to compare temperatures, such as standard deviations of means and chunks, running mean and standard deviation, modal analysis through a Fast Fourier Transform, co-variance, techniques, and other techniques.

If there are, for example, sixteen heating units 234, then sixteen cross-correlations may be performed. In some examples, if a cross-correlation is greater than a threshold value, e.g. 0.95, then a successful cross-correlation is achieved. For example, this may mean that there is no more than a small difference in the temperatures achieved in the area of build material corresponding to a particular heating unit 232, indicating that the heating unit 232 may be functioning normally. However, in some examples, if the cross-correlation is less than 0.95, this may mean that there is a greater difference in the temperatures achieved in the area of build material corresponding to a particular heating unit 232, indicating that the heating unit 232 may be malfunctioning. In this way, whether each of the heating units 234 is malfunctioning may be determined. In some examples, heating unit 232 malfunction may result due to decreased ability to emit heat in the Z-direction of FIG. 2.

In some examples, to aid in the determination of whether a particular heating unit 232 is malfunctioning, information from several counters may be used as well, for example how long the heating unit 232 has been operating (total hours of operation), and how many on/off cycles the heating unit 232 has experienced. For example, heating units 234 with more operating history may be more likely to be malfunctioning.

In some examples, corrections to the correlations may be made based on known differences in distributions 410 and 412. For example, distribution 410 may be obtained while generating a first type of object, and distribution 412 may be obtained while generating a second type of object. The shape of the object may affect the heat emitted by a portion of build material given that portions that solidify may heat to a greater degree than portions that do not solidify. However, in other examples, these corrections may be unnecessary because they represent negligible temperature variations relative to the temperature variations resulting from heater 230 malfunction.

At 320, whether the comparison of 318 indicates heater 230 malfunction, e.g. malfunction of a threshold number of heating units 232 (one, two, three, or any number of heating units 232), may be determined. If heater 230 malfunction is found, the method may proceed to 322, otherwise it may proceed to 310.

At 322, a notification of heater 230 malfunction may be provided. For example, the output device 222 may sound an alarm, display a graphical and/or textual notification indicating heater malfunction 230, and/or indicate that the heater 230 requires servicing. In some examples, the processor 212 cause the heater 230 malfunction event to be logged to a software database in the system 200 or in a network (e.g. Internet) or cloud in communication with the system 200. In some examples, the current object being generated may be cancelled and the method 300 may be terminated.

After a layer of build material has been processed as described above in 310 to 322 (or 310 to 324), new layers of build material may be provided on top of the previously processed layer of build material. In this way, the previously processed layer of build material acts as a support for a subsequent layer of build material. The process of 310 to 322 (or 310 to 324) may then be repeated to generate a three-dimensional object layer by layer.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

1. A system for generating a three-dimensional object, the system comprising:
a heater to heat build material during a three-dimensional print job;
a sensor to measure a temperature distribution of the build material;
a processor to:
obtain first temperature data representing a first temperature distribution of build material associated with normal functioning of the heater;
obtain second temperature data representing a second temperature distribution of the build material to be measured by the sensor during the three-dimensional print job;
compare the first temperature distribution to the second temperature distribution; and
based on the comparison, determine whether the heater is malfunctioning.

2. The system of claim 1 wherein the first temperature distribution is to be measured by the sensor during the three-dimensional print job or a prior three-dimensional print job.

3. The system of claim 1 wherein the first temperature distribution is to be measured by the sensor during a calibration phase prior to the print job.

4. The system of claim 1 wherein the first temperature distribution is to be measured by the sensor during a first period of time during which the heater is to heat the build material and a subsequent second period of time during which a layer of the build material is to be solidified to generate a slice of the three-dimensional object, wherein the second temperature distribution is to be measured by the sensor during a third period of time during which the heater is to heat the build material and a subsequent fourth period of time during which a layer of the build material is to be solidified to generate a slice of the three-dimensional object.

5. The system of claim 1 wherein the heater comprises an array of heating units.

6. The system of claim 1 wherein determining of whether the heater is malfunctioning comprises determining whether a threshold number of heating units are malfunctioning.

7. The system of claim 1 wherein determining whether the heater is malfunctioning comprises determining whether a correlation between the first temperature distribution and second temperature distribution is less than a threshold value.

8. The system of claim 1 wherein the comparison comprises temporally matching the first temperature to the second temperature distribution.

9. The system of claim 1 wherein the sensor is to measure a temperature radiation distribution by measuring a radiation distribution received from the build material.

10. The system of claim 1 further comprising an output device to indicate that the heater is malfunctioning.

11. The system of claim 10 wherein the indication comprises sounding an alarm or displaying a graphical or textual notification.

12. The system of claim 1 wherein the processor is to cause the malfunction to be logged to a software database.

13. The system of claim 1 further comprising:
an agent distributor to selectively deliver a coalescing agent onto a portion of a layer of build material; and
an energy source to apply energy to the layer of build material to cause the portion of the layer to coalesce and solidify; and
wherein the processor is to:
control the agent distributor to selectively deliver the coalescing agent onto the portion of the layer in a pattern; and
control the energy source to apply energy to the layer to cause the portion to coalesce and solidify in the pattern.

14. A method comprising:
obtain, by a processor, reference temperature data representing a reference temperature distribution of build material;
measure, using a temperature sensor, a printing temperature distribution of the build material during a three-dimensional print job;
obtain, from a temperature sensor, printing temperature data representing the printing temperature distribution;
correlate, by the processor, the reference temperature data to the printing temperature data; and
based on the correlation, indicate that a heater used to heat the build material is malfunctioning.

15. A non-transitory computer readable storage medium including executable instructions that, when executed by a processor, cause the processor to:
receive first temperature data representing a first temperature distribution of build material associated with normal functioning of a heating unit of a heater to heat build material during a three-dimensional print job;
obtain second temperature data representing a second temperature distribution of the build material to be measured by the temperature sensor during the three-dimensional print job; and
determine that the heater is malfunctioning based on a comparison of the first temperature distribution and the second temperature distribution.
